(19) United States
(12) Patent Application Publication
(10) Pub. No.: US 2019/0382287 A1
(43) Pub. Date: Dec. 19, 2019

(54) FILTER INSERT FOR A WATER OUTLET FITTING WITH DRINKING WATER FILTER

(71) Applicant: Franke Technology and Trademark Ltd, Hergiswil (CH)

(72) Inventors: Andreas Ruegg, Unterkulm (CH); Markus Leutwiler, Unterkulm (CH); Christoph Kellenberger, Zurich (CH); Michael Loepfe, Zurich (CH)

(73) Assignee: Franke Technology and Trademark Ltd, Hergiswil (CH)

(21) Appl. No.: 16/441,468

(22) Filed: Jun. 14, 2019

(30) Foreign Application Priority Data
Jun. 18, 2018 (DE) 102018114582.9

(51) Int. Cl. C02F 1/44; B01D 29/11; B01D 63/06; B01D 61/02; C02F 1/00; C02F 1/28; C02F 1/50

(52) U.S. Cl. CPC C02F 1/442; B01D 29/114; B01D 63/06; B01D 61/027; C02F 2307/10; C02F 1/283; C02F 1/50; B01D 2311/2626; B01D 2311/2692; C02F 1/003

(57) ABSTRACT

In a filter insert for use in a water outlet fitting with integrated drinking water filter, which has a structure closed on all sides and with an inner hollow space and in which at least a part of its outer surface is designed as a filter-active surface through which water to be filtered passes from the outside inward, a mouthpiece pointing outward in the shape of a collar and forming a mouth orifice is arranged which can be received by an opening in a fitting-side filter housing and from which filtered water can flow freely out of the inner hollow space without contact with the filter housing.

### INCORPORATION BY REFERENCE

The following documents are incorporated herein by reference as if fully set forth: German Patent Application No. DE102018114582.9, filed Jun. 18, 2018.

### BACKGROUND

The present invention relates to a filter insert for use in a water outlet fitting with integrated drinking water filter, wherein the filter insert has a structure closed on all sides and with an inner hollow space, and at least part of its outer surface is designed as a filter-active surface through which water to be filtered passes from the outside inward, and the filter insert has a mouth orifice through which filtered water can flow out of the inner hollow space.

In many locations, the quality of the water from the public water supply or from a dedicated domestic water supply does not meet the hygiene standards required of drinking water. In this case, drinking water filters can be used, by which impurities contained in the service water can be filtered out. For this purpose, retrofittable filter attachments are known which are screwed or plugged onto the mouth orifice of the water outlet of a fitting and which contain a corresponding drinking water filter. Retrofittable filter attachments of this kind are described, for example, in the documents EP 798424 A2, JP 2002/310357, JP 2002/331298 A, WO 1999/037375 A1 or WO 1999/029391 A1. However, such add-on filters attached to the outlet of a fitting are bulky and thus impractical and get in the way during normal use of the fitting, e.g. when drawing service water for cleaning dishes or washing hands.

In addition, fittings are known that have an integrated drinking water filter. For example, EP 2 249 942 B1 discloses a fitting with a filter integrated in the fitting body. The publication US 2014/0215709 A1 describes a fitting with a separate discharge on the fitting body, onto which an upwardly pointing filter cartridge can be attached that has a separate outlet for filtered water mounted on it. Thus, service water and filtered drinking water can be drawn alternately via this fitting.

The fitting described in WO 2013/044329 A1 likewise has a filter accommodated in the fitting body. Two outlets from which service water and filtered drinking water can be optionally drawn are arranged on the fitting body. Moreover, WO 2012/029412 A1 shows schematically a fitting with an outlet for service water, a filter, and, issuing from the filter, a separate outlet for filtered water.

A disadvantage of such fittings with integrated drinking water filter is that, downstream from the filter, there are water-carrying parts of the fitting, in particular valves, a tubular outlet, or water paths formed in the fitting body, in which germs can gather and contaminate the filtered water. Such germ formation inside the fitting can be problematic especially in hot regions. Downstream from the filter, filtered drinking water could then become contaminated with pathogens, without this being noticed.

### SUMMARY

It is therefore an object of the present invention to make available a filter insert for a water outlet fitting with integrated drinking water filter, which is improved in terms of hygiene and safety.

The object is achieved by one or more features of the invention. Advantageous embodiments can be derived from the description that follows and the claims.

In a water outlet fitting of the type mentioned at the outset, provision is made according to the invention that a mouthpiece pointing outward in the form of a collar is arranged on the filter insert and can be received by an opening in a fitting-side filter housing, from which mouthpiece filtered water can flow out freely without contact with the filter housing. According to the present invention, provision is thus made that the filtered drinking water flows directly out of the filter insert when drawn, such that any germ formation in a downstream water path is avoided. By virtue of the closed structure, the entire outer surface of the filter cartridge, which is taken hold of and thus exposed to contamination at the time of insertion, constitutes the “unclean” side of the filter insert, while the interior of the filter insert forms its clean side and is thus protected from environmental influences and contamination.

Preferably, the mouthpiece additionally comprises an integrated jet regulator. Such a jet regulator is usually arranged at the outlet of a fitting and ensures that the water emerges with the desired jet characteristic, and if appropriate in an aerated form, from the outlet. For design reasons, such a jet regulator is particularly susceptible to the accumulation of impurities and can constitute a source of germ formation inside the fitting. Since this jet regulator is now integrated with the filter cartridge as a disposable article, it no longer constitutes a source of germ formation, and it is not necessary to forego the comfort function associated with a jet regulator.

In the delivery state, the mouthpiece arranged on the filter insert can additionally be sealed in a sterile manner by a tear-off film. The latter is removed only when the filter insert is inserted into the filter housing. This ensures that the filter insert is in a perfectly hygienic state, since the mouth orifice as the sole connection point between the sterile interior of the filter insert and the environment is sealed off as long as the filter insert is not in use.

In a preferred embodiment, the filter insert is designed as a cylindrical filter cartridge with a casing surface, two opposite end faces and an axial interior, wherein the mouthpiece is preferably arranged centrally on one of the end faces. The radially symmetrical, in particular cylindrical shape of filter cartridge and filter housing is preferred, since the flow then arrives at the filter cartridge from the outside and the filtered water can be removed directly from the axial interior of the filter. By contrast, the end face of the filter cartridge directed away from the mouthpiece is preferably closed in a water-tight manner.

The filter-active surface is formed substantially by the casing surface of the cylindrical filter cartridge. The end faces are preferably designed as shaped plastic parts which are connected to each other via connection webs extending along the casing surface in the axial direction and spaced apart in the circumferential direction. Such a design is cost-effective and offers a stable support framework for the filter insert. For example, the shaped plastic parts can be configured as injection-molded parts. In this case, it is possible in particular to integrate the end face with the mouthpiece and an integrated jet regulator in the same injection-molded part, which considerably simplifies production.

The support structure of the filter cartridge can in particular be in two parts, namely two shaped plastic parts connected to each other. The connection of these shaped parts can be releasable, preferably by a snap-fit connection, or non-releasable, for example by adhesive bonding or by ultrasonic welding.

In a preferred design of the filter insert, the filter-active surface is provided with a nanoporous polymer membrane. A nanoporous membrane of this kind has a large number of pores in the nano range, e.g. with a pore width of 5-400 nm, preferably 15-200 nm. The pores in the membrane ensure a sufficient passage of water. However, micro-particles contained in the water, for example microbiological impurities, are held back, such that the filtered water is free of germs.

A nanoporous polymer membrane of this kind can be produced by a process in which nanoparticles of a salt, i.e. of an inorganic compound of a metal cation and a non-metal anion, are suspended in a liquid polymer solution, the polymer solution is applied onto a substrate to form a thin membrane and fully polymerized, and then, by the use of a suitable solvent, preferably water, the salt particles are dissolved out of the matrix formed by the polymer.

An additional filter layer with activated carbon can be is arranged to the inside of the nanoporous polymer membrane. It serves as an adsorption element for removing any dyes, flavors or odors remaining in the water after passage through the nanoporous membrane. In particular, gases released by the activated carbon layer, for example chlorine and ozone, are removed and the flavor of the filtered water is thus considerably improved.

Alternatively or in addition, an additional filter layer with active silver particles can be arranged to the inside of the nanoporous polymer membrane. By virtue of the antibacterial action of fine silver particles (nano silver), this ensures that microorganisms do not form in the filter and are unable to contaminate the latter from the inside.

Finally, an additional filter layer of filter nonwoven can be arranged to the outside of the nanoporous polymer membrane as a pre-filter. Coarser particles and contaminants in the water, for example micro-plastic parts, can be retained by such a filter nonwoven and, as a result, cannot settle on the nanoporous membrane and clog the latter.

A filter insert with said filter structure is cost-effective to produce, can be made very compact and yet permits a high flow rate of up to 8 l/min at an external pressure of 3 bar. It permits an almost 100% removal of suspended matter, microorganisms and pathogens (>99%), rust, micro-particles and unpleasant flavors and odors.

In order to seal the filter insert with respect to a fitting-side filter housing, an outwardly protruding annular seal can be applied around the mouthpiece. Thus, with the filter insert, the seal between filter insert and filter housing is also automatically changed, such that no leaks can occur as a result of worn seals, which leaks could cause unfiltered water to flow past the filter insert to the mouth orifice thereof and in this way could contaminate the filtered water.

Moreover, a water outlet fitting with integrated drinking water filter is made available. This has a fitting body with at least one water inlet, an outlet for filtered drinking water, which branches off from the fitting body, and a filter-receiving space for a drinking water filter, which is connected to the outlet in such a way as to carry water. According to the invention, the filter-receiving space is formed by a filter housing which is arranged at the end of the outlet directed away from the fitting body. The filter housing has a downwardly facing bottom with an opening. A filter insert of the above-described kind is inserted into the filter housing, and its outwardly facing mouthpiece is received by the opening in the bottom of the filter housing, such that filtered water can flow freely out without contact with the filter housing.

### BRIEF DESCRIPTION OF THE DRAWINGS

Further advantages and embodiments of the present invention will become clear from the following description of preferred illustrative embodiments and by reference to the figures, in which:

FIG. 1 shows an isometric view of a cylindrical filter cartridge with a mouthpiece mounted thereon,

FIG. 2 shows a plan view of the underside of the filter cartridge from FIG. 1,

FIG. 3 shows a longitudinal section through the filter cartridge from FIG. 1, with an additional tear-off film fitted on the mouthpiece,

FIG. 4 shows the detail X from FIG. 3 concerning the latched connection of the housing parts of the filter cartridge,

FIG. 5 shows a schematic drawing of the structure of the filter layers which are used in a filter cartridge as in FIG. 1,

FIG. 6 shows an isometric view of a water outlet fitting with a separate outlet for filtered water, at the end of which a filter housing is arranged for receiving a filter cartridge, and

FIG. 7 shows a longitudinal section through the filter housing of the fitting from FIG. 6.

### DETAILED DESCRIPTION

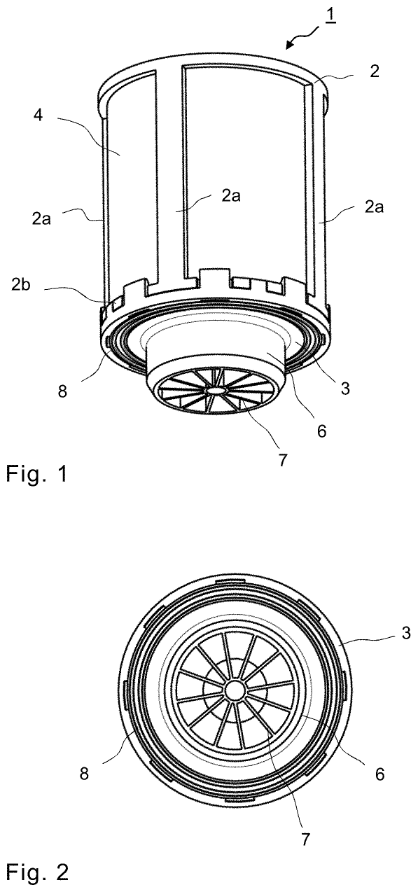

In FIGS. 1 to 3, a cylindrical filter cartridge 1 is shown which is used as a filter insert to filter drinking water in a water outlet fitting. The end faces of the cylindrical filter cartridge 1 are formed by housing parts 2, 3 made of plastic, and the casing surface 4 acts as a filter-active surface and water to be filtered passes through it from the outside inward. The upper housing part 2 comprises the upper end face of the filter cartridge 1 and closes the latter horizontally. From this, connection webs 2a lead to a lower closing-off ring 2b. Four connection webs 2a in total are distributed in the circumferential direction. The lower housing part 3, which forms the lower end face of the filter cartridge 1, is secured on the closing-off ring 2b by means of snap-fit connections.

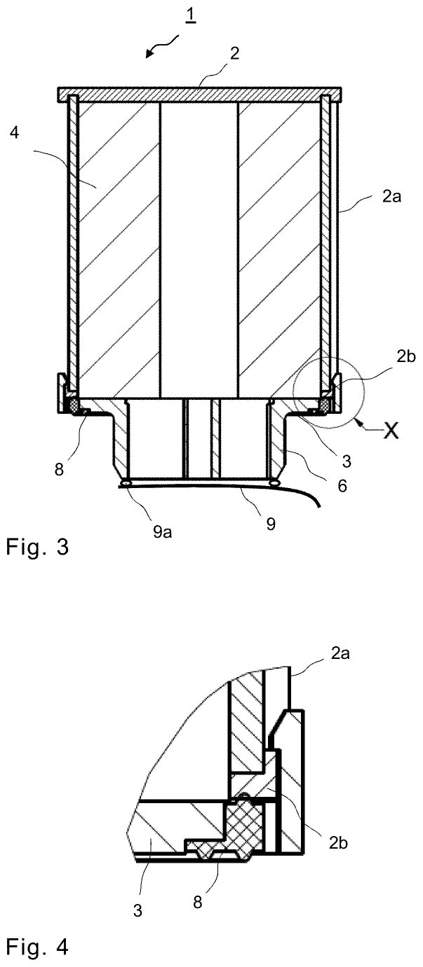

The housing parts 2, 3 are configured as injection-molded plastic parts and form a stabilizing framework for the filter cartridge 1. Inside this framework, the filter-active sheets 4 are arranged in several layers. They enclose an axial interior 5 (see FIG. 3) in which the filtered water arrives. On the underside of the filter cartridge 1, a mouthpiece 6 is formed on the lower housing part 3. It forms a mouth orifice to which water can flow out of the axial interior 5 from the filter cartridge 1.

A jet regulator 7 is integrated in one piece in the mouthpiece 6. A jet regulator is usually arranged at the outlet of a fitting and ensures that the water emerges, if appropriate in an aerated form, with the desired jet characteristics from the outlet. As regards its structure, a jet regulator of this kind is particularly susceptible to the accumulation of contaminants and therefore represents a source of germ formation inside the fitting. Since the jet regulator is now integrated as a disposable item with the filter cartridge 1, it does not represent a source of germ formation, and there is no need to forego the comfort function associated with a jet regulator.

A sealing ring 8 is additionally mounted on the underside of the lower housing part 3. It lies in a ring shape around the mouthpiece 6 and ensures that the filter cartridge 1, when inserted into a fitting-side filter housing, is sealed off from the bottom of the filter housing. In the illustrative embodiment, the seal 8 is designed as two lips, i.e. it has two downwardly facing sealing lips mounted next to each other. The seal 8 is inserted into a downwardly facing groove in the bottom part 3 of the filter cartridge 1.

In the illustrative embodiment, the two housing parts 2, 3 of the filter cartridge are locked onto each other by snap-fit connections. For this purpose, several snap-in hooks 3a are integrally formed on the lower housing part 3 and engage in circumferential recesses in the lower closing-off ring 2b of the upper housing part 2 and lock in said recesses. The detail X from FIG. 3, shown in FIG. 4, depicts the snap-fit connection between upper and lower housing part in an enlarged representation. Such a snap-fit connection is particularly cost-effective and easy to produce. Of course, other ways of connecting the housing parts 2 and 3 are possible within the context of the present and are covered by the latter. For example, the housing parts can be connected cohesively by means of ultrasonic welding.

FIG. 3 also shows that the mouth orifice formed by the mouthpiece 6 is closed in a sterile manner by a tear-off film 9. As is indicated in FIG. 3, the tear-off film 9 can be applied by means of an adhesive join 9a. It is likewise possible to weld the tear-off film 9 to the mouthpiece. The tear-off film 9 prevents the entry of germs and dirt during the storage of the cartridge. The tear-off film is removed before the filter cartridge 1 is inserted into a fitting-side filter housing.

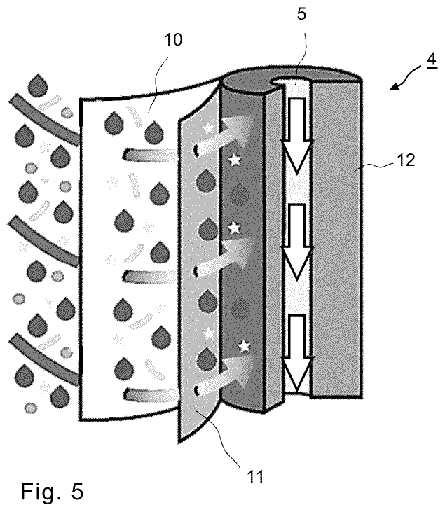

The structure of the filter-active layers 4 is shown schematically in FIG. 5. The outermost filter layer is formed by a filter nonwoven 10. This acts as a pre-filter for coarser contaminants contained in the water. Thereafter, a nanoporous polymer membrane 11 is provided as the next filter layer. Such a membrane is described, for example in the document WO 2012/097967 A1 which, in order to avoid unnecessary repetition, is included herein in full by reference. It has pores with a pore width in the range of between 15 and 200 nm. The pores in the membrane ensure a sufficient passage of water. However, micro-particles contained in the water, for example microbiological impurities, bacteria, viruses and the like are held back, such that the filtered water is germ-free. Finally, at the very inside, there is a filter layer 12 made of or with activated carbon. This ensures that gases contained in the water, for example chorine or ozone, are adsorbed and the filtered water is thus neutral in taste and smell. The filter layer 12 can additionally contain active silver particles which have a microbicidal effect and ensure that no formation of germs can take place in the interior of the filter. The filter layers 10, 11, 12 surround the axial interior 5 of the filter, from which filtered water emerges axially downward through the mouth orifice formed by the mouthpiece 6.

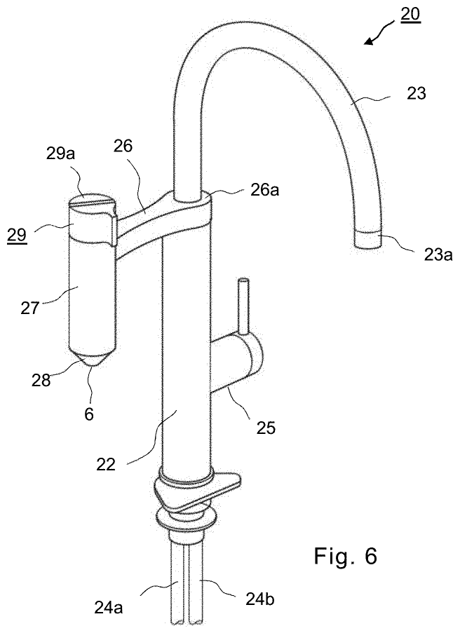

FIG. 6 finally shows a water outlet fitting with an outlet for filtered water, in which a filter cartridge according to the invention can be used as filter insert. The water outlet fitting 20 shown in FIG. 6 comprises a fitting body 22 which is screwed onto a work surface or a kitchen sink. A curved water outlet 23 with a mouthpiece 23a of conventional design, for example a jet regulator, extends upward from the fitting body 22. The water outlet 23 serves as an outlet for water for domestic use. In the context of the invention, water for domestic use is understood as hot water, cold water or mixed water which is drawn from the public water supply or from a house's dedicated water supply but which does not have the quality of drinking water or whose quality as drinking water is questionable.

The water outlet fitting 20 has two delivery lines 24a, 24b for hot water and cold water, and a single-lever mixer 25 with a corresponding valve insert with which the hot and cold water delivered can be mixed and dispensed via the water outlet 23. Inside the fitting body 22, water paths lead in a manner likewise known per se from the delivery lines 24a, 24b to the mixing valve 25 and from there to the water outlet 23.

In the upper region of the fitting body 22, a second outlet line 26 branches off, at the end of which a filter housing 27 is arranged which points perpendicularly downward. In the region of the branching location, the outlet line 26 is configured in the form of an annular shoulder 26a, which lies concentrically about the upwardly facing outlet line 23 and the central axis of the fitting body 22 is pivotable. A water path for cold water runs inside the fitting body 22 to the shoulder 26a and merges there into an annular space formed inside the shoulder 26a, which annular space is open at the periphery and is slidingly sealed relative to the shoulder 26a, and the water passes through it into the second outlet 26.

The filter housing 27 is of approximately cylindrical design and runs together conically toward its base 28. Located in the center of this conical base region 8 is an opening 28a from which filtered drinking water can be dispensed. For this purpose, a valve 29 with a rotary knob 29a is arranged in the upper region of the filter housing 27. When this valve 29 is opened, water flows through the outlet line 26 into an outer annular region 27a of the filter housing 27, passes through the filter-active layers 4 of the filter cartridge 1 inserted in the filter housing 27 and is dispensed axially via the mouthpiece 6.

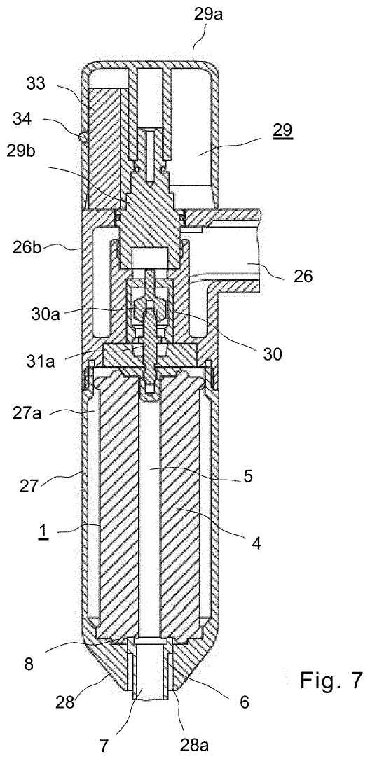

The filter housing 27 is shown enlarged in FIG. 7 in a longitudinal section. At the lower end, the filter cartridge 1 has the mouthpiece 6 which, in the form of a downwardly pointing collar, lies around the outlet opening of the axial interior 5. The diameter of the opening 28a in the bottom 28 of the filter housing 27 is dimensioned such that the mouthpiece 6 passes through it and is received by the opening 28a. Filtered water thus flows through the mouthpiece 6, without coming into contact with the filter housing 27.

The closure valve 29 with its valve knob 29a, and with a valve insert 29b located thereunder, can be seen in the upper region of the filter housing 27. By turning the valve knob 29a, a spindle of the valve insert 29b is actuated and the valve 29 frees the water path from the outlet line 26 into the valve housing 27.

Moreover, between the valve insert 29b and the valve housing 27, there is a non-return valve 30 with a closure body 30a which is held upward in its open position by an actuating pin 31. The actuating pin 31 in turn is held upward by the filter cartridge 1 inserted into the filter housing 37, such that the non-return valve 30 is opened when the filter cartridge 1 is inserted and the filter housing 27 screwed on.

Formed integrally at the end of the water outlet line 26 is a downwardly pointing receiving socket 26b for the filter housing 27, at which the latter is secured in a water-tight manner by a screw fastener or bayonet fastener. When the filter housing 27 is removed in order to change the filter insert 1, the valve body 30a is moved downward to its closed position by the water pressure, or alternatively by a closure spring (not shown here), such that no water can emerge from the outlet line 26.

In operation, with the valve 29 opened and the filter cartridge 1 inserted, water flows out of the outlet line 26 into an outer annular space 27a of the filter housing 27. From there, it flows through the filter material 4 of the filter cartridge 1 and passes into the axial hollow space 5 of the filter cartridge. From there, it flows through the mouthpiece 6 integrally formed on the underside of the filter cartridge 1 and protruding through the opening 28a in the bottom 28 of the filter housing 27, out of the outlet of the fitting 20, for example into a drinking vessel placed under it by a user.

As an additional (optional) function, a battery-operated electrical circuit 33 is integrated in the valve cap 29a and provides information about the state of the filter insert 1 via a multicolor light-emitting diode 34. In the illustrative embodiment, the circuit 33 contains only a timer which is reset after exchange of the filter cartridge 1 and which, after expiry of the preset operating time for the filter cartridge 1, provides a reminder to exchange the latter. However, it is also possible, as an alternative or in addition, to use a flow meter arranged in the water path, for example in the form of an impeller meter, such that an exchange of the filter cartridge 1 can be indicated in accordance with the filtered quantity of water. As long as the filter cartridge 1 is within its intended duration of use, the light-emitting diode 34 flashes green (e.g. every 5 seconds). After the intended duration of use has expired, i.e. when an exchange of the filter cartridge 1 is recommended, the color of the light-emitting diode 34 changes to red. If an exchange of the filter cartridge is omitted and the drinking quality of the filter water is no longer ensured, the rate of flashing is additionally increased as a warning, e.g. rapid flashing at 1× per second.

As has already been explained, the upper end of the filter cartridge 1 is closed by its upper housing part 2. With the filter cartridge 1 inserted, the actuating pin 21 bears on the upper end of the housing part 2 and is held in its upper position by the latter, in which position it holds the non-return valve 30 in the open position. The seal 8 on the underside of the filter cartridge 1 seals off the outer annular space 27a of the filter housing 27 downwardly relative to the bottom 28 of the filter housing 27, such that water having flowed in from the outlet line 26 can pass into the axial interior 5 of the filter insert 1 only after passage through the filter-active layers 4, and from there it can flow out through the mouthpiece 6 mounted on the filter insert.

1. A filter insert (1) for use in a water outlet fitting (20) with an integrated drinking water filter, the filter insert (1) comprising;
a structure with an outer surface that is closed on all sides and with an inner hollow space (5);
at least a part of the outer surface (4) is a filter-active surface through which water to be filtered passes from the outside inward;
a mouth orifice through which filtered water can flow out from the inner hollow space (5);
a collar-shaped mouthpiece (6) pointing outward forms the mouth orifice and is adapted to be received by an opening (28a) in a fitting-side filter housing (27), from which mouthpiece (6) filtered water is adapted to flow freely out without contact with the filter housing (27); and
a jet regulator (7) integrated into the mouthpiece (6).

2. The filter insert as claimed in claim 1, wherein the mouthpiece (6) in a delivery state is sealed in a sterile manner by a tear-off film (9).

3. The filter insert as claimed in claim 1, wherein the structure comprises a cylindrical filter cartridge with a casing surface, two opposite end faces and an axial interior, and the mouthpiece (6) is arranged centrally on one of the end faces.

4. The filter insert as claimed in claim 3, wherein a second one of the end faces of the filter cartridge, directed away from the mouthpiece (6), is closed in a water-tight manner.

5. The filter insert as claimed in claim 4 wherein the filter-active surface (4) is formed substantially by the casing surface, and the end faces comprise shaped plastic parts (2, 3) which are connected to each other via connection webs (2a) extending along the casing surface in an axial direction and spaced apart in a circumferential direction.

6. The filter insert as claimed in claim 1, wherein the filter-active surface (4) is provided with a nanoporous polymer membrane (11).

7. The filter insert as claimed in claim 6, wherein the nanoporous polymer membrane (11) has pores with a pore width of 5-400 nm.

8. The filter insert as claimed in claim 7, further comprising an additional filter layer with activated carbon (12) arranged to an inside of the nanoporous polymer membrane (1).

9. The filter insert as claimed in claim 8, further comprising an additional filter layer with active silver particles (12) arranged to an inside of the nanoporous polymer membrane (11).

10. The filter insert as claimed in claim 9, further comprising an additional filter layer of filter nonwoven (10) arranged at an outside of the nanoporous polymer membrane (11) as a pre-filter.

11. The filter insert as claimed in claim 1, further comprising an outwardly protruding annular seal (8) applied around the mouthpiece (6).

12. A water outlet fitting (21) for dispensing filtered drinking water, comprising:
a fitting body (22) with at least one water inlet (24a, 24b), an outlet (26) for filtered drinking water, which branches off from the fitting body (22), and a filter-receiving space for a drinking water filter (1), which is connected to the outlet (26) in such a way as to carry water;
the filter-receiving space is formed by a filter housing (27) arranged at an end of the outlet (26) directed away from the fitting body (22), the filter housing (27) including a downwardly facing bottom (28) in which an opening (28a) is formed;
a filter insert (1) as claimed in claim 1 inserted into the filter-receiving space; and
the outwardly facing mouthpiece (6) is received by the opening (28a) in the bottom (28) of the filter housing (27), such that filtered water is adapted to flow freely out without contact with the filter housing (27).
